(19) United States
(12) Patent Application Publication
(10) Pub. No.: US 2026/0111576 A1
(43) Pub. Date: Apr. 23, 2026

(54) PRIVACY-PRESERVING MACHINE LEARNING AS A SERVICE FRAMEWORK

(71) Applicant: Dell Products L.P., Round Rock, TX (US)

(72) Inventors: Zijia Wang, London (GB); Min Gong, Shanghai (CN); Mustafa Al-Bado, Cork (IE)

(21) Appl. No.: 18/920,581

(22) Filed: Oct. 18, 2024

(51) Int. Cl. G06F 21/60; G06T 5/60

(52) U.S. Cl. CPC G06F 21/606; G06T 5/60; G06T 2207/20081; G06T 2207/20084

(57) ABSTRACT

In general, certain embodiments described herein relate to a method for performing inferences on noisy compressed data. The method includes receiving, from a client, the noisy compressed data at a machine learning system. The noisy compressed data is transmitted over a network with the machine learning system being a machine learning as a service configuration. An amount of noise in the noisy compressed data is based on a privacy level. The method further includes classifying, by a classifier of the machine learning system, the noisy compressed data by executing an inference on the noisy compressed data to obtain classification results, and transmitting the classification results to the client via a network. The inference is executed by a trained model, which is trained on noisy compressed training data. By transmitting noisy compressed data, the privacy of actual data is preserved.

### BACKGROUND

Machine learning as a service (MLaaS) allows companies to take advantage of machine learning tools without owning specialized infrastructure. Instead, via MLaaS, companies can access these machine learning tools over a network. Traditional frameworks of MLaaS often struggle with balancing efficient data processing, privacy protection, and high accuracy in inference tasks. Further, extensive data transmission and storage pose risks of data breaches and excessive computational overhead.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a system in accordance with one or more embodiments of the invention.

FIG. 2.1 shows a flowchart of a method for training a model of a machine learning system in accordance with one or more embodiments of the invention.

FIG. 2.2 shows a flowchart of a method for performing inferences on noisy compressed data in accordance with one or more embodiments of the invention.

FIG. 3 shows a diagram of an example of an access system using a machine learning system to perform inferences on noisy compressed data in accordance with one or more embodiments of the invention.

FIG. 4 shows a diagram of a computing device in accordance with one or more embodiments of the invention.

### DETAILED DESCRIPTION

In many traditional implementations, data to be used by a machine learning as a service (MLaaS) is transmitted from a client device over a network to a machine learning system. The data is then used to form an inference, which is transmitted back to the client device. The data may be large needing extensive resources for transmission. The data is also vulnerable to being intercepted by cyberattacks while being transmitted and data breaches while stored at the machine learning system.

Traditional approaches to the above problems include the use of compressive sensing to decrease the amount of data being transmitted and potentially adding noise to obfuscate the data being transmitted. However, in these traditional approaches, the noise must be removed from the compressed data and the compressed data needs to be decompressed. Once the data has gone through this pre-processing, inferencing may be performed on this data. Thus, while the data is protected during part of its lifecycle, the data (in its native form) is ultimately available to MLaaS vendors (or providers).

To address the above issues, embodiments of the invention relate to training and using a model for inferencing using noisy compressed data (as opposed to data in its native form). In this manner, the issues related to privacy and the size of transmitted data are minimized. More specifically, embodiments of the invention relate to a method and system performing inferences on noisy compressed data. Embodiments of the invention obtain compressed data from a client. Following the compression, an amount of noise is added to the compressed data to obtain noisy compressed data. The noisy compressed data is then transmitted over a network to a machine learning system. The machine learning system has a model trained on noisy compressed data. A classifier in the machine learning system uses the trained model to classify the noisy compressed data to obtain a classification result. The classification result is transmitted to the client.

One or more embodiments of the invention are directed to improving data transmission and inference quality. The compressive sensing of client data is linked to compression of training data used to train the model for making inferences on the client data. Integrating the compression of the client data and the training data allows a direct inference to be executed on the compressed data. This ensures that the essential features necessary for accurate inference are retained after compression and keeping the data compressed contributes to the privacy of the client data.

One or more embodiments of the invention are directed to improving data privacy during transmission and inference. Noise is added to the client data directly after compression of the data as opposed to the traditional adding of noise after data processing. By adding the noise early in the process, the client data has original data features masked before any potential exposure or processing can occur. By adding noise at the compression stage, the privacy of the client data is protected from the beginning of the process, significantly reducing the potential for privacy breaches. The noise added to the client data is also customizable based on a privacy level that balances the privacy of the client data with the operational requirements of the model.

One or more embodiments of the invention are directed to providing optimizable model training. The model used to make the inference on the client data is trained on similar data that has the same level of noise as the client data. This optimization of the model ensures increased performance and more efficient resource utilization for the model.

The following describes one or more embodiments.

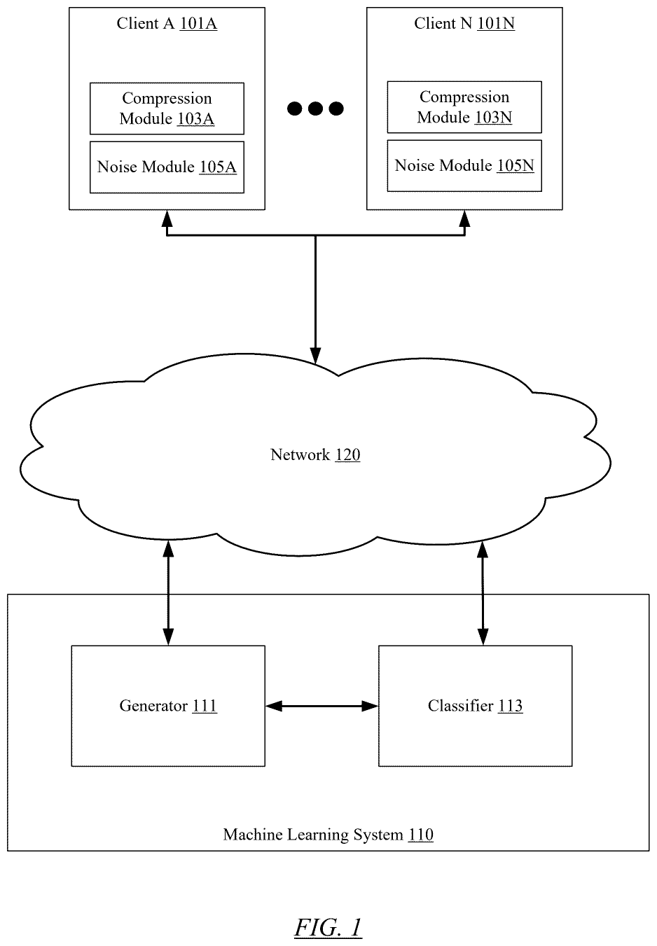

FIG. 1 shows a system in accordance with one or more embodiments of the invention. The system may include any number of client(s) (101A-101N) and a machine learning system (110) all operatively connected to a network (120). Each component illustrated in FIG. 1 is discussed below. The system may include additional, fewer, and/or different components without departing from the invention. For example, in some embodiments the system includes only the client A (101A).

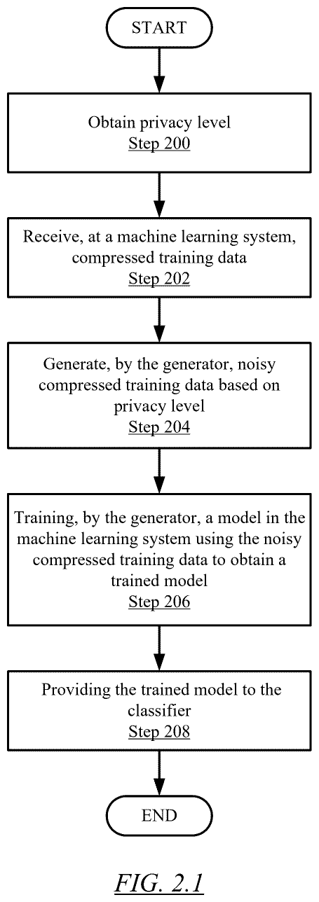

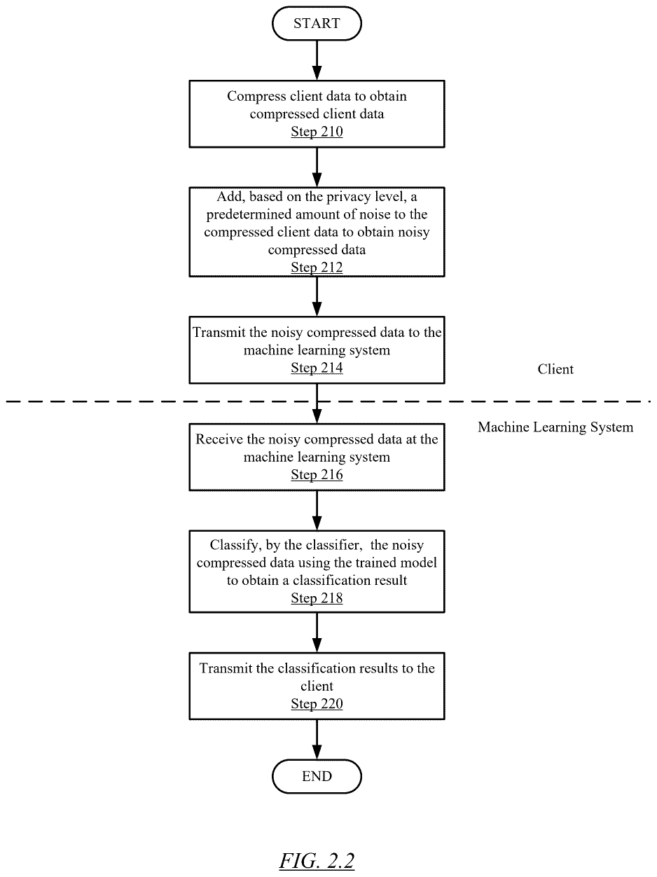

Turning to the client(s) (101A-101N) shown in FIG. 1, the system may include any number of clients (101A-101N) (e.g. client A (101A), client N (101N)). The clients (101A-101N) are described below with reference to the client A (101A), but the description describes all clients including client N (101N). Client A (101A) includes a compression module (103A) and a noise module (105A). The compression module (103A) is used to compress client data as described in FIG. 2.2. The noise module (105A) is used to add noise to the client data as described in FIG. 2.2. The client N (101N) also includes a compression module (103N) and a noise module (105N).

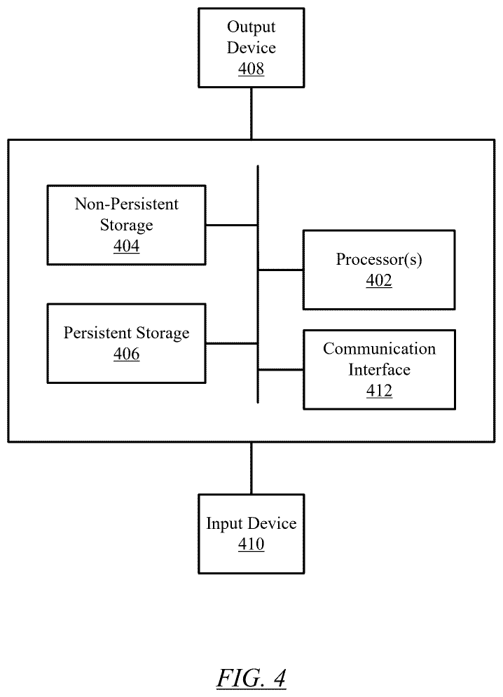

In one or more embodiments of the invention, the client (101A, 101N) may be implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may provide the functionality of the client (101A, 101N) described throughout this application and/or all, or a portion thereof, of the methods illustrated in FIGS. 2.1-2.2.

In one or more embodiments of the invention, the client (101A, 101N) is implemented as a logical device. The logical device may utilize the computing resources of any number of computing devices and thereby provide the functionality of the client (101A, 101N) described throughout this application and/or all, or a portion thereof, of the methods illustrated in FIGS. 2.1-2.2.

Turning to the machine learning system (110), the machine learning system (110) includes a generator (111) and a classifier (113). The generator (111) is operatively connected to the classifier (113). In one or more embodiments, the generator (111) implements a generative adversarial network. The generator (111) is used to train a model as described in FIG. 2.1. The classifier (113) uses the model to classify client data (or otherwise performing inferencing) as described in FIG. 2.2.

In one or more embodiments of the invention, the machine learning system (110) may be implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may provide the functionality of the client (101A, 101N) described throughout this application and/or all, or a portion thereof, of the methods illustrated in FIGS. 2.1-2.2.

In one or more embodiments of the invention, the machine learning system (110) is implemented as a logical device. The logical device may utilize the computing resources of any number of computing devices and thereby provide the functionality of the machine learning system (110) described throughout this application and/or all, or a portion thereof, of the methods illustrated in FIGS. 2.1-2.2.

Turning to the network (120), in one or more embodiments, the network (120) may be a local area network (LAN), a wide area network (WAN) such as the Internet, a mobile network, any other network type, or a combination thereof. Further, the network (120) may encompass various interconnected, network-enabled subcomponents (or systems) (e.g., switches, routers, gateways, etc.) that may facilitate communications between the aforementioned components. Moreover, the clients (101A, 101N) and the machine learning system (110) may communicate with one another over the network (120) using any combination of wired and/or wireless communication protocols.

FIG. 2.1 shows a flowchart of a method for training a model of a machine learning system in accordance with one or more embodiments of the invention. The method of FIG. 2.1 may be performed by, for example, the machine learning system (e.g., 110, FIG. 1). Other components of the system of FIG. 1 may perform all, or a portion, of the method of FIG. 2.1 without departing from the invention.

While the various steps in the flowcharts are presented and described sequentially, one of ordinary skill in the relevant art will appreciate that some or all of the steps may be executed in different orders, may be combined, or omitted, and some or all steps may be executed in parallel. In one embodiment of the invention, the steps shown in FIG. 2.1 may be performed in parallel with any other steps shown in FIGS. 2.1-2.2 without departing from the scope of the invention.

Turning to FIG. 2.1, in step 200, a privacy level is obtained. The privacy level dictates the level of privacy to be given to data transmitted over a network to be used by the machine learning system. The privacy level may be selected by a client and be partially based on factors important to the client (i.e. cost to train the machine learning system, precision required for an inference made by the machine learning system, and necessity of privacy needed for data from the client). The privacy level may be set by the client and transmitted to the machine learning system. The client may be the client (101A, 101N) as shown in FIG. 1. The privacy level provides quantifiable privacy guarantees while being tailored to the machine learning system. The privacy level incorporates principles of differential privacy ensuring that individual data entries are obfuscated to prevent identification or reconstruction even at a lowest privacy level. At a highest privacy level, the functional outputs of the machine learning system are still protected. In one or more embodiments, the privacy level is used to determine an amount of noise to add to the compressed data.

In step 202, compressed training data is received at the machine learning system. The training data is selected and processed such that it is similar to the data to be inferenced by the machine learning system. Using similar data enhances the quality of a model by causing the model to make more accurate inferences. In one or more embodiments, the compressed training data may be received by the client to further enhance the quality of the model by using very similar data. In one or more embodiments, the compressed training data is received from a different source.

In step 204, noisy compressed training data is generated by a generator. The generator is a component of the machine learning system. The generator may be the generator (111) as shown in FIG. 1. In one or more embodiments, the generator is a generative adversarial network (GAN). In one or more embodiments, the generator may be a variational autoencoder (VAE) depending on the application of the machine learning system. The noisy compressed training data is formed from adding an amount of noise to the compressed training data. The amount of noise added to the noisy compressed training data is based on the privacy level. The privacy level is proportional to the amount of noise to be added to data to train and use the machine learning system. Adding the noise to the data is further described in FIG. 2.2.

In one or more embodiments, a function with a Laplace distribution is used to determine the amount of noise. The privacy level and sensitivity needed for the model are inputs for the Laplace distribution. The amount of noise added can be adaptively changed. The amount of noise can be scaled based on real-time analysis of the noisy compressed training data's sensitivity and the operational requirements of the machine learning system. Adjusting the amount of noise ensures a balance between data privacy and accuracy in the inferences of the machine learning system. The amount of noise highlights a tradeoff between the privacy needed for the data and the accuracy needed in the inferences made by the machine learning system. Increasing the privacy of the data will decrease the accuracy of the inferences and vice versa. Utility measures quantify the impact of the noise on the efficacy of the inferences made. The utility measures are then used to optimize the noise parameters and the amount of noise leading to a balance between the privacy and efficiency. Empirical studies and simulations may be conducted to validate the amount of noise used.

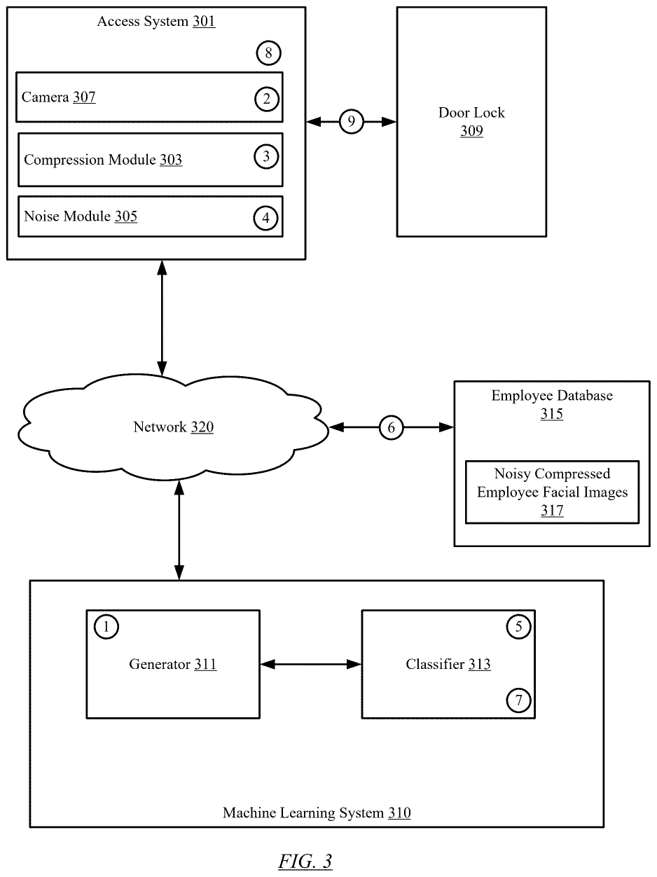

In step 206, a model is trained by the generator to obtain a trained model. The model is in the machine learning system. The noisy compressed training data is used to train the model. By training the model with noisy compressed training data that is similar to data to be used to make inferences, the model is optimized for the specific data that will be inferenced. The trained model can also make an inference directly on noisy compressed data bypassing full data reconstruction used in traditional models. The generator trains the model to make inferences on data. In one or more embodiments, the inference may be whether the data is present in a database as shown in the example in FIG. 3.

The generator trains the model to identify data characteristics of the data prior to compression and added noise. This restores or approximates original data characteristics while traditional methods focus on data generation from noise. The training is critical for enabling the model to effectively approximate the original data characteristics that have been changed due to compression and adding noise. To accomplish this task, the generator uses a tailored loss function that incorporates terms used for data fidelity and compression artifacts (i.e. distortions caused by compression) reduction. Advanced optimization of the training ensures convergence of the trained model.

In step 208, the trained model is provided to a classifier. The classifier is a component of the machine learning system. The classifier may be the classifier (113) as shown in FIG. 1. The classifier uses the trained model to make inferences as shown in FIG. 2.2

FIG. 2.2 shows a flowchart of a method for performing inferences on noisy compressed data in accordance with one or more embodiments of the invention. The method of FIG. 2.2 may be performed, in part, by, for example, the client A (e.g., 101A, FIG. 1) and, in part, by the machine learning system (e.g., 110, FIG. 1). Other components of the system of FIG. 1 may perform all, or a portion, of the method of FIG. 2.2 without departing from the invention.

While the various steps in the flowcharts are presented and described sequentially, one of ordinary skill in the relevant art will appreciate that some or all of the steps may be executed in different orders, may be combined, or omitted, and some or all steps may be executed in parallel. In one embodiment of the invention, the steps shown in FIG. 2.2 may be performed in parallel with any other steps shown in FIGS. 2.1-2.2 without departing from the scope of the invention.

In step 210, client data is compressed to obtain compressed data. The client data is compressed by a compression module. The compression module may be the compression module (103A) as shown in FIG. 1. The compression of the client data mirrors the compression of the training data as shown in FIG. 2.1. This increases the efficiency of the inference of the machine learning system. The compression module uses compressive sensing to compress the client data. Compressive sensing does not require uniform sampling of the data at a high rate. Instead, compressive sensing enables sampling below the Nyquist rate, which decreases the amount of data needed to be transmitted in stored after compression.

Compression sensing is represented by the following equation.

$$y = Φ x + n ,$$

where x is the client data in vector form, y is the compressed client data in vector form, Φ is a measurement matrix, and n is measurement noise. Compression sensing is enhanced by using machine learning to adaptively optimize the measurement matrix. The measurement matrix is optimized to include necessary data characteristics improving the accuracy of the interference to be made on the data.

In step 212, a predetermined amount of noise is added to the compressed client data to obtain noisy compressed data. The predetermined amount of noise is based on the privacy level. The noise is added by a noise module. The noise module may be the noise module (105A) as shown in FIG. 1. The amount of noise corresponds to the amount of noise added to the compressed training data as shown in FIG. 2.1 for the reasons discussed in FIG. 2.1. However, the amount of noise added may be adaptively changed in response to the training of the model in step 206. The amount of noise added to the compressed client data being similar to the amount of noise added compressed training data increases the accuracy of the inference to be made on the noisy compressed data. Adding noise is represented by the following equation.

$${y}_{n} = y + η ,$$

where y is the compressed client data in vector form, η is the amount of noise added, and yₙ is the noisy compressed data in vector form. The amount of noise to add is described in FIG. 2.1.

In step 214, the noisy compressed data is transmitted to the machine learning system. The noisy compressed data is transmitted over a network. The network may be the network (120) as shown in FIG. 1. The machine learning system is a MLaaS configuration so the noisy compressed data must be sent over a network since the machine learning system is not hosted with the client.

In step 216, the noisy compressed data is received at the machine learning system. The noisy compressed data is transmitted to the classifier to be used as an input for the trained model. The noisy compressed data is secure during transmission and storage at the machine learning system due to the added noise and compression.

In step 218, the noisy compressed data is classified to obtain a classified result. The noisy compressed data is classified by the classifier using the trained model as shown in FIG. 2.1. The classifier uses the trained model from FIG. 2.1 to obtain an inference on the noisy compressed data. The noisy compressed data is inputted into the trained model. The trained model's inference classifies the noisy compressed data. In one or more embodiment, the noisy compressed data is compared to a separate dataset to determine if the noisy compressed data is a member of the separate dataset. In one or more embodiment, the noisy compressed data is classified in a different way.

In step 220, the classification results are transmitted to the client. The classification results are transmitted over the network. The client then may use the classification results to complete a process such as the one shown in the Example in FIG. 3.

### Example

The following section describes an example. The example, illustrated in FIG. 3, is not intended to limit the invention and is independent from any other examples discussed in this application. Turning to the example, consider a scenario in which an access system controlling access to a door to a facility (i.e. physical location). The access system utilizes MLaaS to determine whether the door should be unlocked for a user requesting access. The access system takes an image of the user and sends it to a machine learning system to perform an inference on the image to determine if the user is an employee that should be allowed in the door and grants or denies access to the facility based on the inference.

Turning to the example, FIG. 3 shows a diagram of an access system using a machine learning system to perform inferences on noisy compressed data in accordance with one or more embodiments of the invention as an example.

For the sake of brevity, not all components of the example system may be illustrated in FIG. 3. The system may include an access system (301), a door lock (309), and an employee database (315). The system further includes a machine learning system (310) and a network (320) like shown in FIG. 1. The components in FIG. 3 have the same or substantially the same functionality as the like named components in FIG. 1. The access system (301) includes a compression module (303) and a noise module (305). The access system (301) further includes a camera (307). The access system (301) is operatively connected to a door lock (309) and configured to operate the door lock (309). The employee database (315) includes noisy compressed employee facial images. The machine learning system (310) includes a generator (311) and a classifier (313) like shown in FIG. 1. The access system (301), the machine learning system (310), and the employee database (315) are connected to the network (320).

Starting at the generator (311), the generator (311) trains a model using noisy compressed training data to obtain a trained model. The generator receives compressed training data from a source. The compressed training data is similar to compressed client data to be used later in the process. The similarity of the data ensures accurate inferences. The generator adds noise to the compressed training data that corresponds to a privacy level to be used by the access system (301). The trained model is then provided to the classifier (313) [1].

Moving to the access system (301), a user approaches the camera (307) of the access system (301) to gain access to the facility. The camera (307) takes an image of the user [2]. The access system (301) compresses the image into a compressed image at the compression module (303) [3]. Then, the access system (301) adds noise to the compressed image to create noisy compressed data from the compressed image [4]. The amount of noise added corresponds to the privacy level. The privacy level is selected to ensure the privacy of the data and to ensure the accuracy of the inference on the data. The noisy compressed data is transmitted over the network (320) to the classifier (313) [5].

At the classifier (313), the classifier (313) receives noisy compressed employee facial images (317) from an employee database (315) [6]. The classifier then classifies the noisy compressed data by making an inference about whether the noisy compressed data obtained in [5] contains an image that corresponds to an image in the noisy compressed employee facial images (317). The classifier obtains a classification result based on the inference [7]. The classification result is transmitted to the access system (301) via the network (320) [8].

Returning to the access system (301), if the classification result specifies that the noisy compressed data matches one of the noisy compressed employee facial images, the access system (301) determines that the user is an employee and the door is unlocked to grant access to the user. If the classification result specifies that, the noisy compressed data does not match one of the noisy compressed employee facial images, the access system (301) determines that the user is not an employee and the door remains locked to deny access to the user. In this example, the classification results state the noisy compressed data is a match to one of the noisy compressed employee facial images. The access system (301) then determines that the user is an employee and transmits an order to unlock the door to the door lock (309) [9]. The door is then unlocked granting access to the user.

In the above example, the machine learning system (310) never has access to native images or compressed images; rather, the machine learning system (310) only has access to noisy compressed data. This approach, among other advantages, protects the employee's privacy.

### End of Example

As discussed above, embodiments of the invention may be implemented using computing devices. FIG. 4 shows a diagram of a computing device in accordance with one or more embodiments of the invention. The computing device may include one or more computer processor(s) (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the processor(s) (402) may be an integrated circuit for processing instructions. For example, the computer processor(s) may be one or more cores or micro-cores of a processor. The computing device may also include one or more input devices (410), such as a touchscreen, keyboard, mouse, microphone, touchpad, electronic pen, or any other type of input device. Further, the communication interface (412) may include an integrated circuit for connecting the computing device to a network (not shown) (e.g., a local area network (LAN), a wide area network (WAN) such as the Internet, mobile network, or any other type of network) and/or to another device, such as another computing device.

In one embodiment of the invention, the computing device may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

The problems discussed above should be understood as being examples of problems solved by embodiments of the invention disclosed herein and the invention should not be limited only to solving the same/similar problems. The disclosed invention is broadly applicable to address a range of problems beyond those discussed herein.

Specific embodiments are described with reference to the accompanying figures. In the above description, numerous details are set forth as examples of the invention. It will be understood by those skilled in the art, that one or more embodiments of the present invention may be practiced without these specific details, and that numerous variations or modifications may be possible without departing from the scope of the invention. Certain details known to those of ordinary skill in the art are omitted to avoid obscuring the description.

In the prior description of the figures, any component described with regard to a figure, in various embodiments of the invention, may be equivalent to one or more like-named components described with regard to any other figure. For brevity, descriptions of these components are not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for performing inferences on noisy compressed data, comprising:
receiving, from a client, the noisy compressed data at a machine learning system, wherein an amount of noise in the noisy compressed data is based on a privacy level;
classifying, by a classifier of the machine learning system, the noisy compressed data by executing an inference on the noisy compressed data to obtain classification results; and
transmitting the classification results to the client via a network.

2. The method of claim 1, wherein prior to receiving the noisy compressed data at the machine learning system, the method further comprises:
receiving, at the machine learning system, compressed training data;
generating, using the privacy level and the compressed training data, noisy compressed training data;
training, using a generator in the machine learning system, a model in the machine learning system using the noisy compressed training data to obtain a trained model; and
providing the trained model to the classifier.

3. The method of claim 2, wherein the generator is a generative adversarial network (GAN).

4. The method of claim 1, wherein the amount of noise is proportional to the privacy level.

5. The method of claim 1,
wherein the noisy compressed data is generated by an access system controlling access to a physical location.

6. The method of claim 5, wherein the access system obtains an image, compresses the image to obtain a compressed image, and creates the noisy compressed data based on the compressed image and the privacy level.

7. The method of claim 6, wherein classifying the noisy compressed data comprises using a trained model to determine whether the noisy compressed data matches second noisy compressed data in a database.

8. The method of claim 7, wherein the classification results specifies that there is a match between the noisy compressed data and the second noisy compressed data, wherein the access system uses the classification results to grant access to the physical location.

9. The method of claim 1, wherein the classification results received by the client determine if a user should be granted access to the client.

10. A non-transitory computer readable medium comprising computer readable program code, which when executed by a computer processor enables the computer processor to perform a method for performing inferences on noisy compressed data, the method comprising:
receiving, from a client, the noisy compressed data at a machine learning system, wherein an amount of noise in the noisy compressed data is based on a privacy level;
classifying, by a classifier of the machine learning system, the noisy compressed data by executing an inference on the noisy compressed data to obtain classification results; and
transmitting the classification results to the client via a network.

11. The non-transitory computer readable medium of claim 10, wherein prior to receiving the noisy compressed data at the machine learning system, the method further comprises:
receiving, at the machine learning system, compressed training data;
generating, using the privacy level and the compressed training data, noisy compressed training data;
training, using a generator in the machine learning system, a model in the machine learning system using the noisy compressed training data to obtain a trained model; and
providing the trained model to the classifier.

12. The non-transitory computer readable medium of claim 11, wherein the generator is a generative adversarial network (GAN).

13. The non-transitory computer readable medium of claim 10, wherein the amount of noise is proportional to the privacy level.

14. The non-transitory computer readable medium of claim 10,
wherein the noisy compressed data is generated by an access system controlling access to a physical location.

15. The non-transitory computer readable medium of claim 14, wherein the access system obtains an image, compresses the image to obtain a compressed image, and creates the noisy compressed data based on the compressed image and the privacy level.

16. The non-transitory computer readable medium of claim 15, wherein classifying the noisy compressed data comprises using a trained model to determine whether the noisy compressed data matches second noisy compressed data in a database.

17. The non-transitory computer readable medium of claim 16, wherein the classification results specifies that there is a match between the noisy compressed data and the second noisy compressed data, wherein the access system uses the classification results to grant access to the physical location.

18. The non-transitory computer readable medium of claim 10, wherein the classification results received by the client determine if a user should be granted access to the client.

19. A machine learning system, comprising:
a processor;
storage comprising instructions, which when executed by the processor perform a method, the method comprising:
receiving, at the machine learning system, compressed training data;
generating, using a privacy level and the compressed training data, noisy compressed training data;
training, using a generator in the machine learning system, a model in the machine learning system using the noisy compressed training data to obtain a trained model; and
providing the trained model to a classifier of the machine learning system.

20. The system of claim 19, wherein an amount of noise added to the compressed training data to generate the noisy compressed training data is proportional to the privacy level.
